(19) United States
(12) Patent Application Publication
(10) Pub. No.: US 2024/0326753 A1
(43) Pub. Date: Oct. 3, 2024

(54) Unknown

(71) Applicant: Robert Bosch GmbH, Stuttgart (DE)

(72) Inventor: Michael Schaeuble, Vaihingen An Der Enz (DE)

(21) Appl. No.: 18/615,187

(22) Filed: Mar. 25, 2024

(30) Foreign Application Priority Data
Mar. 29, 2023 (DE) 10 2023 202 854.9

(51) Int. Cl. B60S 1/56; B60S 1/48

(52) U.S. Cl. CPC B60S 1/56; B60S 1/485

(57) ABSTRACT

The invention proceeds from a cleaning procedure for a cleaning system (12a; 12b; 12c; 12d), in particular wash system, of an at least partially automated mobile vehicle (10a; 10b; 10c; 10d), for cleaning at least a partial area (18a; 18b; 18c; 18d) of a vehicle window (14a; 14b; 14c; 14d) of the vehicle (10a; 10b; 10c; 10d) and for cleaning at least a partial area (22a; 22b; 22c; 22d) of a field of view (16a; 16b; 16c; 16d) of a, in particular optical, driving assistance sensor (20a; 20b; 20c; 20d) of the vehicle (10a; 10b; 10c; 10d), such as a LiDAR sensor, a camera sensor, a video sensor or the like, wherein the cleanable partial areas (18a; 18b; 18c; 18d, 22a; 22b; 22c; 22d) of the field of view (16a; 16b; 16c; 16d) and the vehicle window (14a; 14b; 14c; 14d), at least partially overlap.

It is proposed that when the cleaning system (12a; 12b; 12c; 12d), in particular the wash system, be manually initiated to clean the vehicle window (14a; 14b; 14c; 14d) during an at least partially automated driving operation of the vehicle (10a; 10b; 10c; 10d), it is determined whether a cleaning program for cleaning the driving assistance sensor (20a; 20b; 20c; 20d) is currently active.

### BACKGROUND

A cleaning procedure has already been proposed for a cleaning system of an at least partially automated mobile vehicle, for cleaning at least a partial area of a vehicle window of the vehicle and for cleaning at least a partial area of a field of view of a, in particular optical, driving assistance sensor of the vehicle, such as a LiDAR sensor, a camera sensor, a video sensor or the like, wherein the cleanable partial areas of the field of view and the vehicle window at least partially overlap.

### SUMMARY

The invention proceeds from a cleaning procedure for a cleaning system, in particular wash system, of an at least partially automated mobile vehicle, for cleaning at least a partial area of a vehicle window of the vehicle and for cleaning at least a partial area of a field of view of a, in particular optical, driving assistance sensor of the vehicle, such as a LiDAR sensor, a camera sensor, a video sensor or the like, wherein the cleanable partial areas of the field of view and the vehicle window at least partially overlap.

It is proposed that when the cleaning system, in particular the wash system, is manually initiated to clean the vehicle window during an at least partially automated driving operation of the vehicle, it be determined whether a cleaning program for cleaning the driving assistance sensor is currently active.

As a result of the configuration of the cleaning procedure according to the invention, a high operational safety can advantageously be provided, as in particular an active, functional and/or safety-relevant cleaning program cannot be overwritten by a manual initiation of the cleaning system, in particular wash system. Advantageously, a high level of safety can be provided for vehicle occupants, as in particular a possible impairment of the safety of the at least partially automated vehicle can be prevented by manual initiation of the cleaning system, in particular wash system. Advantageously, a high level of comfort can be provided, as in particular even in an at least partially automatically operated vehicle, the cleaning system, in particular wash system, can be manually initiated to clean the vehicle window.

Preferably, the at least one, in particular optical, driving assistance sensor is arranged at least partially, preferably at least substantially entirely, in or on the vehicle. In particular, the driving assistance sensor is arranged behind the vehicle window of the vehicle, in particular in a passenger compartment. In particular, the driving assistance sensor at least substantially contacts the vehicle window. In particular, the driving assistance sensor comprises at least one sensor field surface. In particular, the sensor field surface of the driving assistance sensor is at least substantially formed by the vehicle window. It is contemplated that the driving assistance sensor can be integrated into a rear view mirror base. Preferably, the driving assistance sensor is configured to monitor an environment and/or provide measurement data that is used at least to control the vehicle. Preferably, the driving assistance sensor is configured as a LiDAR sensor and/or LiCam sensor and/or video sensor and/or camera sensor. Preferably, the driving assistance sensor is configured to detect at least one amount of precipitation and/or contamination. Preferably, the driving assistance sensor comprises at least one field of view. Preferably, the field of view of the driving assistance sensor is defined at least by the sensor field surface. Preferably, the vehicle is configured as a car and/or truck and/or ship and/or aircraft and/or drone. Preferably, an autonomous and/or partially automated driving function of the vehicle is enabled by the at least one driving assistance sensor. In particular, the vehicle is permanently fully operable in an autonomous driving function, in particular without human intervention. In particular, the vehicle is configured in a partially automated driving function to temporarily perform predefined driving situations at least partially independently, in particular without human intervention. In particular, the vehicle can be controlled at least partially without the intervention of a human/vehicle occupant in at least the partially automated driving function. In particular, the partially automated driving function of the vehicle is enabled by the at least one driving assistance sensor. It is contemplated that the partially automated driving function is broken into sub-groups. For example, the sub-groups could be configured as partially automated driving and/or highly automated driving and/or a fully automated driving or the like. In addition, the vehicle can be manually operated, in particular controlled by a driver. The term “configured” is in particular understood to mean specifically programmed, designed, and/or equipped. The phrase “an object being provided for a specific function” is particular configured and/or provided to mean that the object fulfills and/or performs this specific function in at least one application and/or operating state.

In this context, the term “driver assistance sensor” is in particular understood as a sensor that monitors an environment of the vehicle and transmits it to a controller of the vehicle. The vehicle controller can calculate and/or issue control commands, warnings, advisories, or suggestions for vehicle operation based on the sensor data. Preferably, a measurement principle of the driving assistance sensor is based on a reception and/or emission of electromagnetic beams. In particular, the electromagnetic beams pass through the sensor field, especially the vehicle window and/or a protective cover of the sensor, before being received. In particular, after being emitted, the electromagnetic beams pass through the sensor field, especially the vehicle window and/or a protective cover of the sensor. It is conceivable that the sensor is provided for high-frequency distance and speed measurement for object detection and/or collision avoidance. The sensor can, e.g., be used to control and regulate autonomous, and/or computer-assisted operation of vehicles or to support manual driving operation, e.g., by a lane departure warning system, a parking assistant, a distance warning system, a hazard detection system, and many more. It is also conceivable that the sensor, in particular one of the sensors, is designed as a radar sensor.

Preferably, the vehicle comprises a cleaning system, in particular wash system, which is configured to clean at least the one partial area of the vehicle window. In particular, the cleaning system, in particular wash system, could comprise at least one wiper, in particular windshield wiper and/or sensor field wiper, and/or a washing water tank and/or washing water lines and/or washing water nozzles and/or other components that appear to be useful to the person skilled in the art. Preferably, the windshield wiper is configured to clean the vehicle window in particular, or at least the partial area of the vehicle window. In particular, the partial area of the field of view of the driving assistance sensor is arranged at least partially in the partial area of the vehicle window. Preferably, the partial area of the field of view of the driving assistance sensor and the partial area of the vehicle window are cleaned by the same windshield wiper. In particular, at least a portion of the partial area of the vehicle window and the partial area of the field of view of the driving assistance sensor are cleaned simultaneously, preferably in the same cleaning operation. Preferably, cleaning of the at least one field of view, particularly in an autonomous and/or partially automated driving function of the vehicle, is initiated and/or controlled and/or monitored automatically by the controller and/or an internal and/or external control and/or regulating unit.

Preferably, after manual initiation, a cleaning status of the cleaning system, in particular wash system, is queried. For example, after manual initiation of the cleaning system, in particular wash system, it is checked whether a cleaning program is currently being executed or whether the field of view of the optical driving assistance sensor needs to be cleaned. For example, after manual initiation, it could be determined how long the currently active cleaning program will last and/or when the currently active cleaning program will end. A “manual initiation” is to be understood in particular to mean a cleaning request initiated by a vehicle occupant/operator.

Furthermore, it is proposed that the cleaning of the driving assistance sensor be prioritized over manually initiated cleaning of the vehicle window. Advantageously, a particularly high operational reliability can be provided, as the automatically initiated cleaning of the vehicle window is in particular prioritized. Advantageously, a high cleaning efficiency can be provided, as an optimum cleaning program selection and/or sequence can be provided, in particular by prioritization. Advantageously, a high level of comfort, in particular operator comfort, can be provided to the vehicle occupants, as in particular the manually initiated cleaning of the vehicle window is optimally considered in the cleaning program selection. Preferably, the manually initiated cleaning of the vehicle window is performed as soon as there is no, preferably safety-relevant, cleaning requirement for cleaning the field of view of the driving assistance sensor. It is contemplated that it could be checked whether the manually initiated cleaning of the vehicle window and the cleaning of the driving assistance sensor can be performed simultaneously. In particular, “prioritized” should be understood to mean an assessment and subsequent ranking determination of at least two instructions, which cannot be carried out simultaneously.

It is further proposed that a current driving situation, in particular one detected and/or determined by the vehicle, be used to decide whether the cleaning program for cleaning the driving assistance sensor is to be continued without interruption or whether the cleaning program for cleaning the driving assistance sensor is at least interrupted to allow the vehicle window to be cleaned. Advantageously, a particularly high operational safety can be provided, as in particular it is checked whether a cleaning program can be interrupted or whether the cleaning program is continued, in particular for safety reasons. Advantageously, a high efficiency can be provided, as the driving situation in particular is taken into account in the prioritization. For example, based on the current travel situation, a vehicle speed, visibility, traffic density, amount of precipitation, or the like could be considered. In particular, the driving situation data could be read and/or determined from a vehicle controller and/or from navigation data and/or from measurement data of the driving assistance sensors or the like.

In addition, it is proposed that the at least partially automated driving operation of the vehicle be deactivated if a cleaning program for cleaning the driving assistance sensor is active when the cleaning system, in particular wash system, is manually initiated. Advantageously, a high operational safety can be provided, as in particular an at least partially autonomous operation is switched off when optimum safety can no longer be ensured. Advantageously, a particularly high level of operating comfort can be provided, as the cleaning of the vehicle window can be forced in any operating state by manually initiating the cleaning system, in particular wash system. Preferably, the at least partially automated driving operation is deactivated by switching the at least partially automated driving operation to manual driving operation. In particular, the at least partially automated driving operation is deactivated by active driver intervention, for example by active control of the vehicle. Alternatively, the driver or another vehicle occupant could also be requested to control the vehicle.

Furthermore, it is proposed that the cleaning program for cleaning the driving assistance sensor be time-controlled, in particular recurringly, and/or automatically initiated based on contamination recognition. Advantageously, a high cleaning performance and/or cleaning efficiency can be provided, as in particular cleaning is performed only when the driving assistance sensor to be cleaned has detected contamination. Preferably, a cleaning requirement of the driving assistance sensor is determined based on a level of contamination and/or a level of wetting of the field of view of the driving assistance sensor determined by a cleaning requirement control unit of the driving assistance sensor. Preferably, the cleaning program is automatically initiated as soon as a, in particular predefined, level of contamination is exceeded. Preferably, the time interval is configured to be adjustable.

Furthermore, a cleaning apparatus with a cleaning system, in particular wash system, for an at least partially automated mobile vehicle is proposed, wherein the cleaning system, in particular wash system, is configured for cleaning at least a partial area of a vehicle window of the vehicle and for cleaning at least a partial area of a field of view of a, in particular optical, driving assistance sensor of the vehicle, such as a LiDAR sensor, a camera sensor, a video sensor or the like, and wherein the cleanable partial areas of the field of view and the vehicle window at least partially overlap, which comprises a control or regulating unit which is configured at least to determine whether a cleaning program for cleaning the driving assistance sensor is currently active when the cleaning system, in particular wash system, is manually initiated, for cleaning the vehicle window during at least partially automated driving operation of the vehicle. Advantageously, a high level of automation of the operation function can be provided, as in particular the control and/or regulating unit automatically checks whether a cleaning program for cleaning the driving assistance sensor is currently active. It is contemplated that the control and/or regulating unit is configured as the controller of the vehicle. The term “control and/or regulating unit” should in particular be understood to mean a unit with at least one control electronics. The term “control electronics” should in particular be understood to mean a unit with a processor unit and with a memory unit as well as with an operating program stored in the memory unit.

Furthermore, it is proposed that the cleaning system, in particular wash system, comprise a common washing water tank for providing washing water for cleaning the driving assistance sensor and the vehicle window and/or a common compressed air system for providing compressed air for cleaning the driving assistance sensor and the vehicle window. Advantageously, a low assembly complexity can be provided, as in particular only a washing water tank and/or only a common compressed air system need to be mounted. Preferably, the cleaning system, in particular wash system, comprises at least one pump, which is arranged at least partially in the washing water tank. In particular, the pump is configured to provide a fluid pressure. In particular, the cleaning system, in particular wash system, comprises at least two washing water circuits which are configured to be operable separately from one another. It is contemplated that the two washing water circuits can be switched to form one washing water circuit. Preferably, the compressed air system comprises at least one compressed air reservoir and a compressor. Preferably, the compressor is configured to generate a fluid pressure. It is contemplated that a compressed air system already present on the vehicle can be used as the compressed air system for cleaning the driving assistance sensor and the vehicle window.

It is further proposed that the cleaning system, in particular wash system, comprise a valve unit configured to controllably provide washing water for cleaning the driving assistance sensor and for at least one further driving assistance sensor of the vehicle. Advantageously, an assembly complexity can be reduced, as in particular a variety of hoses and connecting elements can be dispensed with due to the valve unit. Advantageously, a high control speed can be provided, as in particular only the valve has to be switched, because the washing water pressure is already present. Preferably, the valve unit is configured as a distribution unit. Preferably, the valve unit comprises at least one, in particular electronically controllable, multi-port valve. In particular, a “multi-port valve” is to be understood to mean a component for a, in particular electronically, controllable at least partial shut-off and/or at least partial opening of a plurality of outputs, wherein each output can be controlled separately. Preferably, the valve unit comprises at least two washing water circuits each comprising a washing water pump for supplying the washing water circuit. In particular, the at least two washing water circuits can be connected to one another, for example in emergency operation, wherein the at least two washing water circuits are configured as a redundant system.

In addition, the control and/or regulating unit of the cleaning apparatus is proposed. Advantageously, a high cleaning efficiency can be provided, as an optimum cleaning program selection and/or sequence can be provided, in particular by prioritization performed by the control and/or regulating unit. Advantageously, a high level of automation of the operation function can be provided, as in particular the control and/or regulating unit automatically provides an optimum cleaning program selection and/or an optimum cleaning program sequence. It is contemplated that the control and/or regulating unit can be configured as an external, for example cloud-based, computing unit.

In addition, a partially automated mobile vehicle is proposed, which comprises at least one driving assistance sensor and at least one vehicle window and a cleaning apparatus. Advantageously, a high level of safety can be provided for vehicle occupants, as in particular a possible impairment of the safety of the at least partially automated vehicle can be prevented by manual initiation of the cleaning system, in particular wash system. Advantageously, a high level of comfort can be provided, as in particular even in an at least partially automatically operated vehicle, the cleaning system, in particular wash system, can be initiated manually to clean the vehicle window.

The cleaning procedure according to the invention for a cleaning system, in particular wash system, the cleaning apparatus according to the invention, the control and/or regulating unit according to the invention, and the vehicle according to the invention are not intended to be limited to the application and embodiment described above. In particular, the cleaning procedure for a cleaning system, in particular wash system, according to the invention, the cleaning apparatus according to the invention, the control and regulating unit according to the invention and the vehicle according to the invention can comprise a number of individual elements, components and units as well as method steps different from a number mentioned herein for fulfilling a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. Four embodiment examples of the invention are shown in the drawings. The drawings, the description, and the claims contain numerous features in combination. A person skilled in the art will appropriately also consider the features individually and combine them into additional advantageous combinations.

Shown are:

FIG. 1 a schematic illustration of a vehicle with a cleaning apparatus for cleaning a partial area of a vehicle window and a field of view of a driving assistance sensor,

FIG. 2 a schematic illustration of the vehicle window with the driving assistance sensor and with the cleaning apparatus,

FIG. 3 a schematic flowchart of a cleaning procedure for the cleaning apparatus,

FIG. 4 a schematic illustration of a first alternative cleaning apparatus,

FIG. 5 a schematic illustration of a second alternative cleaning apparatus and

FIG. 6 a schematic illustration of the vehicle with a third alternative cleaning apparatus.

### DETAILED DESCRIPTION

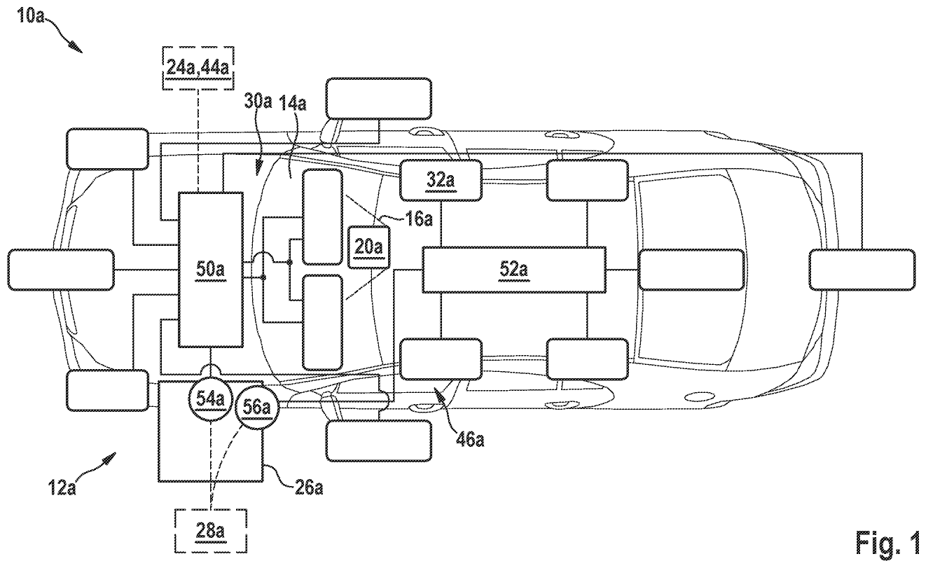

FIG. 1 shows a schematic representation of a vehicle 10a. The vehicle 10a is configured to drive in a partially automated manner. The vehicle 10a can also be operated manually. The vehicle 10a can include further operating modes, such as autonomous driving and/or fully automated driving and/or highly automated driving, and/or further intermediate stages that can appear useful to those skilled in the art. The vehicle 10a is designed as a passenger car. The vehicle 10a could also be designed as a utility vehicle. The vehicle 10a comprises a controller 44a. The controller 44a is configured to control the vehicle 10a. The vehicle 10a comprises a vehicle window 14a. The vehicle window 14a is configured as a windshield. The vehicle window 14a partially delimits a passenger compartment 46a of the vehicle 10a.

The vehicle 10a comprises a driving assistance sensor 20a. The driving assistance sensor 20a is designed as an optical driving assistance sensor. The driving assistance sensor 20a could be configured as a LiDAR sensor, a camera sensor, a video sensor, or the like. The driving assistance sensor 20a has a field of view 16a. The vehicle 10a comprises a further driving assistance sensor 32a. The further driving assistance sensor 32a is configured as an optical driving assistance sensor. The further driving assistance sensor 32a could be configured as a LiDAR sensor, a camera sensor, a video sensor, or the like. The further driving assistance sensor 32a has a further field of view. The vehicle 10a comprises a total of 12 driving assistance sensors. It is contemplated that the vehicle 10a can have a plurality of additional driving assistance sensors.

The vehicle 10a comprises a cleaning apparatus. The cleaning apparatus comprises a cleaning system 12a. The cleaning system 12a is configured as a wash system. Alternatively or additionally, the cleaning system is configured as a compressed air system or another cleaning system that appears useful to the person skilled in the art. The cleaning system 12a comprises a common washing water tank 26a. The common washing water tank 26a is configured to provide washing water for cleaning the driving assistance sensor 20a and the vehicle window 14a. Alternatively or additionally, the cleaning system 12a comprises a common compressed air system 28a for providing compressed air for cleaning the driving assistance sensor 20a and the vehicle window 14a. The cleaning system 12a comprises a valve unit 30a. The valve unit 30a is configured to controllably provide washing water for cleaning the driving assistance sensor 20a and for a further driving assistance sensor 32a of the vehicle 10a and for the additional driving assistance sensors. The valve unit 30a comprises multiple valves. The valve unit 30a comprises a valve box 50a. The valve box 50a is configured to provide washing water for cleaning the driving assistance sensor 20a and the additional driving assistance sensors. The valve box 50a is incorporated in a washing water circuit. The washing water circuit comprises the valve box 50a and a pump 54a and the common washing water tank 26a. It is contemplated that the washing water circuit can comprise further washing water circuit components such as filters, pressure measurement units, washing water lines, connection elements, electrical control elements, or the like. The valve box 50a has a washing water inlet. The valve box 50a has eight washing water outlets. The eight washing water outlets are individually electronically controllable. Six valves of valve box 50a are configured to supply six driving assistance sensors with washing water for cleaning. Two valves of the valve box 50a are configured to supply a windshield wiper 48 with washing water for cleaning the vehicle window 14a. The valve unit 30a comprises a further valve box 52a. The further valve box 52a is configured to provide washing water for cleaning the further driving assistance sensors 32a and the additional driving assistance sensors. The further valve box 52a is incorporated in a further washing water circuit. The further washing water circuit comprises the further valve box 52a and a further pump 56a and the common washing water tank 26a. It is contemplated that the further washing water circuit can comprise further washing water circuit components such as filters, pressure measurement units, washing water lines, connection elements, electrical control elements, or the like. The further valve box 52a has a further washing water inlet. The further valve box 52a has eight further washing water outlets. The eight further washing water outlets are individually electronically controllable. Six further valves of the further valve box 50a are configured to supply five further driving assistance sensors with washing water for cleaning. It is contemplated that the washing water circuit and the further washing water circuit can be interconnected. The vehicle 10a comprises a control and/or regulating unit 24a. The cleaning apparatus comprises a control and/or regulating unit 24a. The control and/or regulating unit 24a is configured to determine whether a cleaning program for cleaning the driving assistance sensor 20a is currently active when the cleaning system 12a is manually initiated to clean the vehicle window 14a during a partially automated/autonomous driving operation of the vehicle 10a. The control and/or regulating unit 24a could also be configured as the controller of vehicle 10a.

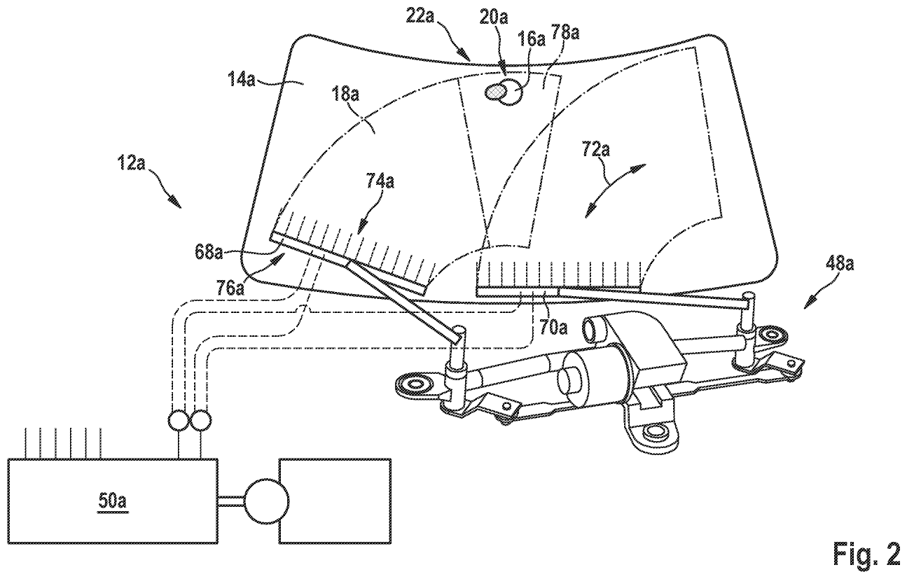

FIG. 2 shows the cleaning system 12a. The cleaning system 12a comprises the windshield wiper 48a. The windshield wiper 48a comprises a wiper 68a. The windshield wiper 48a comprises a further wiper 70a. The cleaning system 12a is configured to clean a partial area 18a of the vehicle window 14a of the vehicle 10a. The partial area 18a of the vehicle window 14a is configured as the surface of the vehicle window 14a swept by the windshield wiper 48a. The cleaning system 12a is configured to clean the field of view 16a of the driving assistance sensor 20a. The cleaning system 12a is configured to clean a partial area 22a of the field of view 16a of the driving assistance sensor 20a. The partial area 22a of the field of view 16a is arranged entirely within the partial area 18a of the vehicle window 14a. The windshield wiper 48a is configured to be moved back and forth to a zone 78a in order to clean the field of view 16a of the driving assistance sensor 20a. The driving assistance sensor 20a is partially formed by the vehicle window 14a. The cleanable partial areas 18a, 22a of the field of view 16a and the vehicle window 14a are arranged to overlap. Alternatively, the partial areas 18a, 22a of the field of view 16a and vehicle window 14a could also be partially overlapping. The windshield wiper 48a has a direction of movement 72a. A valve of the valve box 50a supplies washing water to the wiper 68a and the further wiper 70a of windshield wiper 48a on a same longitudinal side 74a of the wiper 68a, 70a. The further one of the two valves of the valve box 50a for supplying washing water to the windshield wiper 48a supplies washing water to the wiper 68a and the further wiper 70a of the windshield wiper 48a on a further same longitudinal side 76a opposite the same longitudinal side 74a. The same longitudinal side 74a of the wipers 68a, 70a is the longitudinal side of the wipers 68a, 70a arranged in front of the wipers 68a, 70a in the direction of movement 72a of the wipers 68a, 70a. The further same longitudinal side 76a is the longitudinal side of the wipers 68a, 70a arranged downstream of the wipers 68a, 70a in the direction of movement 72a of the wipers 68a, 70a. In a wiping operation, a maximum of one valve for supplying washing water to the windshield wiper 48a is active at the same time. During the wiping operation, the valves for supplying the longitudinal sides 74a, 76a arranged in a direction of movement 72a of the wiper 68a and the further wiper 70a are active.

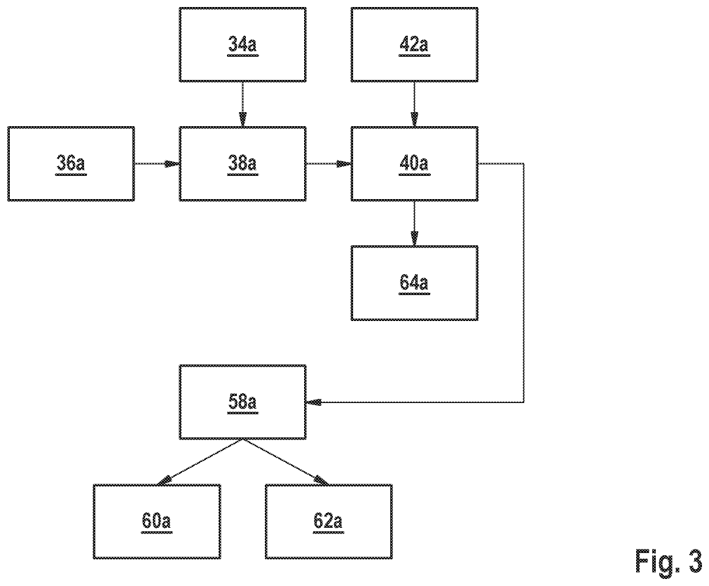

FIG. 3 shows a schematic flowchart of a cleaning procedure for a cleaning system 12a. In a method step 34a, vehicle operation is started. For example, vehicle operation is started by turning on an engine of the vehicle 10a. Alternatively, vehicle operation could be started by starting a partially automated or autonomous vehicle operation from a manual vehicle operation. Furthermore, it is checked whether the vehicle 10a is operating in a manual or automated or autonomous driving mode. When the vehicle 10a is operated in the autonomous or partially automated driving mode, a further method step 36a is selected.

In the further method step 36a, a cleaning requirement of the driving assistance sensor 20a is checked. The cleaning requirement is determined by the end of a time interval. For example, cleaning could be initiated after 5 minutes or a comparable time interval. Alternatively or additionally, a positive cleaning requirement is determined by the driving assistance sensor 20a by detecting contamination from the driving assistance sensor 20a and/or requesting a cleaning requirement.

In a further method step 38a, it is checked whether a cleaning program for cleaning the driving assistance sensor 20a is started or whether there is not a sufficient cleaning requirement. Furthermore, it could be determined when a cleaning program is likely to need to be started. In the further method step 38a, the cleaning of the driving assistance sensor 20a is automatically started. Cleaning of the driving assistance sensor 20a is automatically started when there is a positive cleaning requirement. The cleaning program for cleaning the driving assistance sensor 20a is automatically initiated on a time-controlled, recurring basis and/or based on a contamination recognition.

In a further method step 42a, the cleaning system 12a is manually initiated. For example, the cleaning system 12a could be manually initiated by a driver/vehicle occupant initiating activation of the windshield wiper 48a. Alternatively, a cleaning requirement of the vehicle window 14a could be automatically detected and the cleaning system 12a could be automatically initiated.

In a further method step 40a, it is determined whether a cleaning program for cleaning the driving assistance sensor 20a is active when the cleaning system 12a is manually initiated to clean the vehicle window 14a during a partially automated driving operation of the vehicle 10a. If, at the time of manual initiation of the cleaning system 12a, a cleaning program is not active or imminent, the windshield wiper 48a is activated to clean the vehicle window 14a.

In a further method step 58a, cleaning of the driving assistance sensor 20a is prioritized over manually initiated cleaning of the vehicle window 14a. In the further method step 58a, a current driving situation detected and/or determined by the vehicle 10a is used to decide whether the cleaning program for cleaning the driving assistance sensor 20a is to be continued without interruption or whether the cleaning program for cleaning the driving assistance sensor 20a is at least interrupted to allow the vehicle window 14a to be cleaned. For example, the cleaning of the driving assistance sensor 20a could be temporarily interrupted when driving on a highway with a low traffic volume.

In a further method step 60a, the cleaning program for cleaning the driving assistance sensor 20a is interrupted. Following the manually initiated cleaning of the vehicle window 14a, the cleaning program for cleaning the driving assistance sensor 20a is automatically continued and/or automatically restarted.

In a further method step 62a, the cleaning program for cleaning the driving assistance sensor 20a is performed until the end of the cleaning program. The manually initiated cleaning of the vehicle window 14a is performed automatically upon completion of the automatically initiated cleaning program.

In a further method step 64a, the partially automated driving operation of the vehicle 10a is deactivated when a cleaning program for cleaning the driving assistance sensor 20a is active when the cleaning system 12a is manually initiated.

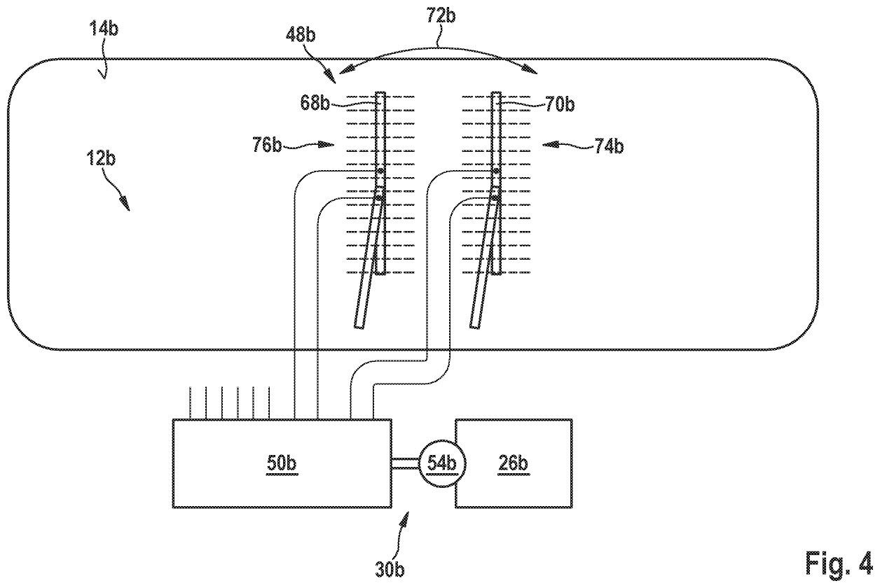

FIGS. 4 to 6 show further embodiment examples of the invention. The following descriptions and the drawings are essentially limited to the differences between the embodiment examples, wherein reference can, in principle, also be made, with respect to identically designated components, in particular with respect to components with the same reference numbers, to the drawings and/or the description of the other embodiment examples, in particular FIGS. 1 to 3. In order to distinguish between the embodiment examples, the letter a has been added to the reference numbers for the embodiment example in FIGS. 1 through 3. In the embodiment examples of FIGS. 4 to 6, letter a is replaced by letters b through d.

FIG. 4 shows a schematic representation of a first alternative cleaning system 12b. The first alternative cleaning system 12b comprises a windshield wiper 48b. The windshield wiper 48b comprises a wiper 68b. The windshield wiper 48b comprises a further wiper 70b. The windshield wiper 48b has a direction of movement 72b. The first alternative cleaning system 12b comprises a first alternative valve unit 30b. The first alternative valve unit 30b comprises a first alternative valve box 50b. The first alternative valve box 50b is incorporated in a washing water circuit. The washing water circuit comprises the first valve box 50b and a pump 54b and a common washing water tank 26b. It is contemplated that the washing water circuit can comprise further washing water circuit components such as filters, pressure measurement units, washing water lines, connection elements, electrical control elements, or the like. The first alternative valve box 50b has a washing water inlet. The first alternative valve box 50b has ten washing water outlets. The ten washing water outlets are individually electronically controllable. Four valves of the first alternative valve box 50a are configured to supply the windshield wiper 48b with washing water for cleaning a vehicle window 14b. The wiper 68b has a longitudinal side 74b. The wiper 68b has a further longitudinal side 76b. The wiper 70b has a longitudinal side 74b. The wiper has a further longitudinal side 76b. The longitudinal side 74b and the further longitudinal side 76b of the wiper 68b have a washing water connection. The longitudinal side 74b and the further longitudinal side 76b of the further wiper 70b have a washing water connection. In a wiping operation, a maximum of two valves for supplying washing water to the windshield wiper 48b are active at the same time. During the wiping operation, the valves for supplying the longitudinal sides 74b, 76b arranged in a direction of movement 72b of the wiper 68b and the further wiper 70b are active.

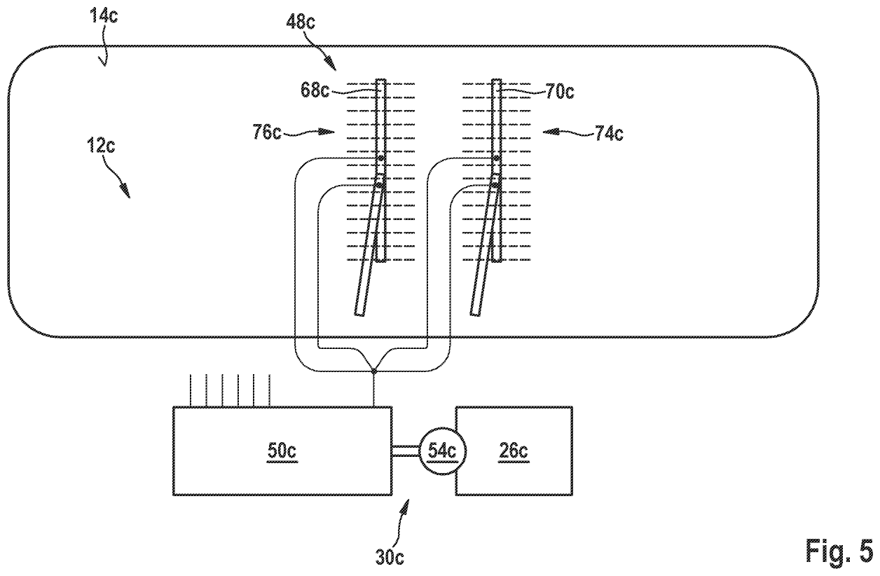

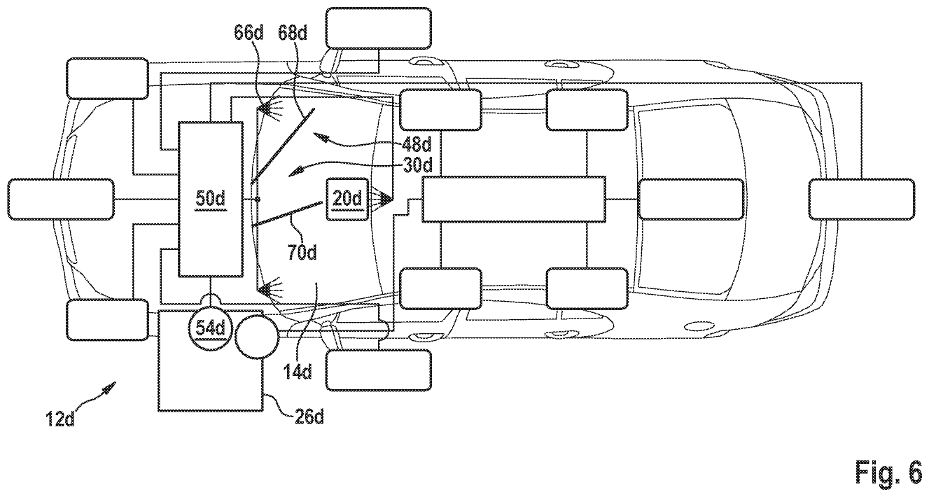

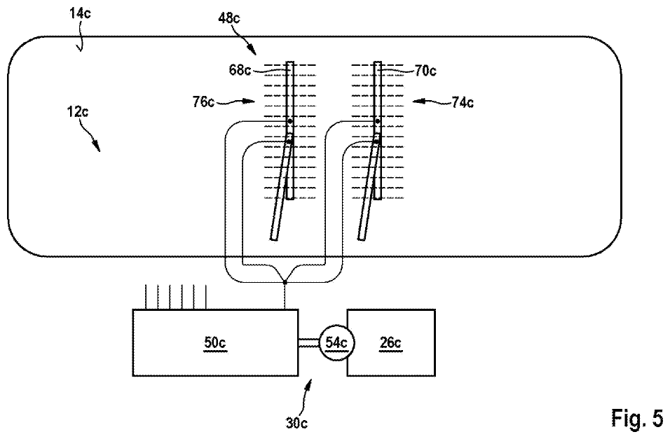

FIG. 5 shows a schematic diagram of a second alternative cleaning system 12c. The second alternative cleaning system 12c comprises a windshield wiper 48c. The windshield wiper 48c comprises a wiper 68c. The windshield wiper 48c comprises a further wiper 70c. The second alternative cleaning system 12c comprises a second alternative valve unit 30c. The second alternative valve unit 30c comprises a second alternative valve box 50c. The second alternative valve box 50c is incorporated in a washing water circuit. The washing water circuit comprises the second alternative valve box 50c and a pump 54c and a common washing water tank 26c. It is contemplated that the washing water circuit can comprise further washing water circuit components such as filters, pressure measurement units, washing water lines, connection elements, electrical control elements, or the like. The second alternative valve box 50c has a washing water inlet. The second alternative valve box 50c has seven washing water outlets. The seven washing water outlets are individually electronically controllable. One valve of the second alternative valve box 50c is configured to supply the windshield wiper 48c with washing water for cleaning a vehicle window 14c. The wiper 68c has a longitudinal side 74c. The wiper 68c has a further longitudinal side 76c. The further wiper 70c has a further longitudinal side 74c. The first longitudinal side 74c and the further longitudinal side 76c of the wiper 68c and the further wiper 70c have a washing water connection. In a wiping operation, all four longitudinal sides 74c, 76c of the wiper 68c, 70c are active simultaneously or disabled simultaneously.

FIG. 6 shows a schematic diagram of a third alternative cleaning system 12d. The third alternative cleaning system 12d comprises a windshield wiper 48d. The windshield wiper 48d comprises a wiper 68d. The windshield wiper 48d comprises a further wiper 70d. The third alternative cleaning system 12d comprises a third alternative valve unit 30d. The third alternative valve unit 30d comprises a third alternative valve box 50d. The third alternative valve box 50d is incorporated in a washing water circuit. The washing water circuit comprises the third alternative valve box 50d and a pump 54d and a common washing water tank 26d. It is contemplated that the washing water circuit can comprise further washing water circuit components such as filters, pressure measurement units, washing water lines, connection elements, electrical control elements, or the like. The third alternative valve box 50d has a washing water inlet. The third alternative valve box 50d has seven washing water outlets. The washing water outlets are individually electronically controllable. A valve of the third alternative valve box 50d is configured to supply washing water to two washing water nozzles 66d for washing water application to the vehicle window 14d to be cleaned. The two washing water nozzles 66d provide washing water to the wiper 68d and the further wiper 70d.

1. A cleaning procedure for a cleaning system (12a; 12b; 12c; 12d), an at least partially automated mobile vehicle (10a; 10b; 10c; 10d) for cleaning at least a partial area (18a; 18b; 18c; 18d) of a vehicle window (14a; 14b; 14c; 14d) of the vehicle (10a; 10b; 10c; 10d) and for cleaning at least a partial area (22a; 22b; 22c; 22d) of a field of view (16a; 16b; 16c; 16d) of an optical, driving assistance sensor (20a; 20b; 20c; 20d) of the vehicle (10a; 10b; 10c; 10d), wherein the cleanable partial areas (18a; 18b; 18c; 18d, 22a; 22b; 22c; 22d) of the field of view (16a; 16b; 16c; 16d) and the vehicle window (14a; 14b; 14c; 14d) at least partially overlap, wherein when the cleaning system (12a; 12b; 12c; 12d), is manually initiated to clean the vehicle window (14a; 14b; 14c; 14d) during an at least partially automated driving operation of the vehicle (10a; 10b; 10c; 10d), it is determined whether a cleaning program for cleaning the driving assistance sensor (20a; 20b; 20c; 20d) is currently active.

2. The cleaning procedure according to claim 1,
wherein the cleaning of the driving assistance sensor (20a; 20b; 20c; 20d) is prioritized over manually initiated cleaning of the vehicle window (14a; 14b; 14c; 14d).

3. The cleaning procedure according to claim 2,
wherein a decision is made based on the current driving situation detected and/or determined by the vehicle (10a; 10b; 10c; 10d) as to whether the cleaning program for cleaning the driving assistance sensor (20a; 20b; 20c; 20d) is continued without interruption or whether the cleaning program for cleaning the driving assistance sensor (20a; 20b; 20c; 20d) is at least interrupted in order to permit cleaning of the vehicle window (14a; 14b; 14c; 14d).

4. The cleaning procedure according to claim 1, wherein the at least partially automated driving operation of the vehicle (10a; 10b; 10c; 10d) is deactivated if a cleaning program for cleaning the driving assistance sensor (20a; 20b; 20c; 20d) is active when the cleaning system (12a; 12b; 12c; 12d) is manually initiated.

5. The cleaning procedure according to claim 1, wherein the cleaning program for cleaning the driving assistance sensor (20a; 20b; 20c; 20d) is time-controlled and/or automatically initiated based on contamination recognition.

6. A cleaning apparatus for performing a cleaning procedure according to claim 1, with a cleaning system (12a; 12b; 12c; 12d) for an at least partially automated mobile vehicle (10a; 10b; 10c; 10d), wherein the cleaning system (12a; 12b; 12c; 12d) is configured for cleaning at least a partial area (18a; 18b; 18c; 18d) of a vehicle window (14a; 14b; 14c; 14d) of the vehicle (10a; 10b; 10c; 10d) and for cleaning at least a partial area (22a; 22b; 22c; 22d) of a field of view (16a; 16b; 16c; 16d) of an optical, driving assistance sensor (20a; 20b; 20c; 20d) of the vehicle (10a; 10b; 10c; 10d), and wherein the cleanable partial areas (18a; 18b; 18c; 18d, 22a; 22b; 22c; 22d) of the field of view (16a; 16b; 16c; 16d) and the vehicle window (14a; 14b; 14c; 14d) at least partially overlap, wherein a control and/or regulating system (24a; 24b; 24c; 24d) is configured to determine, when the cleaning system (12a; 12b; 12c; 12d), is manually initiated to clean the vehicle window (14a; 14b; 14c; 14d) during an at least partially automated driving operation of the vehicle (10a; 10b; 10c; 10d), whether a cleaning program for cleaning the driving assistance sensor (20a; 20b; 20c; 20d) is currently active.

7. The cleaning apparatus according to claim 1, wherein the cleaning system (12a; 12b; 12c; 12d), comprises a common washing water tank (26a; 26b; 26c; 26d) for providing washing water for cleaning the driving assistance sensor (20a; 20b; 20c; 20d) and the vehicle window (14a; 14b; 14c; 14d) and/or a common compressed air system (28a; 28b; 28c; 28d) for providing compressed air for cleaning the driving assistance sensor (20a; 20b; 20c; 20d) and the vehicle window (14a; 14b; 14c; 14d).

8. A cleaning apparatus according to claim 7, wherein the cleaning system (12a; 12b; 12c; 12d), comprises a valve unit (30a; 30b; 30c; 30d) which is configured for a controllable supply of washing water for the cleaning the driving assistance sensor (20a; 20b; 20c; 20d) and for at least one further driving assistance sensor (32a; 32b; 32c; 32d) of the vehicle (10a; 10b; 10c; 10d).

9. A control and/or regulating unit (24a; 24b; 24c; 24d) of a cleaning apparatus according to claim 7.

10. A partially automated mobile vehicle (10a; 10b; 10c; 10d) with at least one driving assistance sensor (20a; 20b; 20c; 20d), with at least one vehicle window (14a; 14b; 14c; 14d), and with a cleaning apparatus according to claim 1, wherein the cleaning system (12a; 12b; 12c; 12d), comprises a common washing water tank (26a; 26b; 26c; 26d) for providing washing water for cleaning the driving assistance sensor (20a; 20b; 20c; 20d) and the vehicle window (14a; 14b; 14c; 14d) and/or a common compressed air system (28a; 28b; 28c; 28d) for providing compressed air for cleaning the driving assistance sensor (20a; 20b; 20c; 20d) and the vehicle window (14a; 14b; 14c; 14d).
